(19) United States
(12) Patent Application Publication
(10) Pub. No.: US 2019/0337511 A1
(43) Pub. Date: Nov. 7, 2019

(54) System and Method for Controlling an Autonomous Vehicle

(71) Applicant: GM GLOBAL TECHNOLOGY OPERATIONS LLC, DETROIT, MI (US)

(72) Inventors: Leon Nguyen, Santa Ana, CA (US); Kyungnam Kim, Oak Park, CA (US); Michael J. Daily, Thousand Oaks, CA (US); Vincent De Sapio, Westlake Village, CA (US); Joonho Lee, Troy, MI (US)

(21) Appl. No.: 15/969,279

(22) Filed: May 2, 2018

(51) Int. Cl. B60W 30/095; B60W 30/09; B60W 40/04

(52) U.S. Cl. CPC B60W 30/0956; B60W 2550/10; B60W 40/04; B60W 30/09

(57) ABSTRACT

An automotive vehicle includes an actuator configured to control vehicle acceleration, steering, or braking. The vehicle additionally includes at least one sensor configured to detect an object in the vicinity of the vehicle. The vehicle further includes at least one controller configured to automatically control the actuator according to an automated driving system algorithm. The at least one controller is configured to define a first vehicle route, detect at least one object in the vicinity of the vehicle; calculate a probabilistic forecast of a future location of the at least one detected object, define a second vehicle route in response to the probabilistic forecast indicating proximity of the at least one detected object to the first route, and to control the actuator to execute the second vehicle route.

### TECHNICAL FIELD

The present disclosure relates to vehicles controlled by automated driving systems, particularly those configured to automatically control vehicle steering, acceleration, and braking during a drive cycle without human intervention.

### INTRODUCTION

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

### SUMMARY

An automotive vehicle according to the present disclosure includes an actuator configured to control vehicle acceleration, steering, or braking. The vehicle additionally includes at least one sensor configured to detect an object in the vicinity of the vehicle. The vehicle further includes at least one controller configured to automatically control the actuator according to an automated driving system algorithm. The at least one controller is configured to define a first vehicle route, detect at least one object in the vicinity of the vehicle; calculate a probabilistic forecast of a future location of the at least one detected object, define a second vehicle route in response to the probabilistic forecast indicating proximity of the at least one detected object to the first route, and to control the actuator to execute the second vehicle route.

In an exemplary embodiment, the probabilistic forecast comprises a two-dimensional heatmap of a vicinity of the vehicle. In such embodiments, the at least one detected object may include a first object and a second object, with a relative path of the first object intersecting the first vehicle route and a relative path of the second object not intersecting the vehicle route. The heatmap includes a gaussian distribution associated with the first object and no gaussian distribution associated with the second object.

A method of controlling an automotive vehicle according to the present disclosure includes providing a vehicle with an actuator configured to control vehicle acceleration, steering, or braking, at least one sensor configured to detect an object in the vicinity of the vehicle, and at least one controller configured to automatically control the actuator according to an automated driving system algorithm. The method additionally includes detecting, via the at least one sensor, at least one object in the vicinity of the vehicle. The method also includes calculating, via the controller, a probabilistic forecast of a future location of the at least one detected object. The method further includes defining a vehicle path from a current vehicle location to a desired future vehicle location, with the vehicle path being based on the probabilistic forecast. The method still further includes automatically controlling the actuator, via the controller, to execute the vehicle path.

In an exemplary embodiment, defining a vehicle path includes defining a time-parametrized path having a first set of time parameters, and the probabilistic forecast includes a second set of time parameters corresponding to the first set of time parameters. Such embodiments may additionally include, in response to the probabilistic forecast indicating proximity of the at least one detected object to the time parametrized path, defining a second vehicle path from the current vehicle location to the desired future location, with the second vehicle path not being proximate the at least one detected object. Such embodiments may further include, in response to the second vehicle path being within a predefined range of the vehicle path, automatically controlling the actuator, via the controller, to execute the second vehicle path.

In an exemplary embodiment, the probabilistic forecast comprises a two-dimensional heatmap of a vicinity of the vehicle. In such embodiments, the at least one detected object may include a first object and a second object, with a relative path of the first object intersecting the first vehicle route, a relative path of the second object not intersecting the vehicle route, and the heatmap including a gaussian distribution associated with the first object and no gaussian distribution associated with the second object.

Embodiments according to the present disclosure provide a number of advantages. For example, the present disclosure provides a system and method for controlling an autonomous vehicle to avoid contacting other objects or vehicles, and moreover does so in a computationally-efficient manner.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic diagram of a communication system including an autonomously controlled vehicle according to an embodiment of the present disclosure;

FIG. 2 is a schematic block diagram of an automated driving system (ADS) for a vehicle according to an embodiment of the present disclosure;

FIG. 3 is a representation of an intersection calculation according to an embodiment of the present disclosure;

FIGS. 4A and 4B show an illustrative traffic scenario and corresponding heatmap, respectively, according to an embodiment of the present disclosure;

FIGS. 5A and 5B illustrate a method of controlling a vehicle based on probabilistic heat maps according to an embodiment of the present disclosure;

FIG. 6 illustrates a bicycle model of a vehicle according to an embodiment of the present disclosure;

FIG. 7 illustrates a simulation of nonholonomic vehicle dynamics responding to a force imposed on a vehicle according to an embodiment of the present disclosure; and

FIG. 8 is a flowchart representation of a method of controlling a vehicle according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

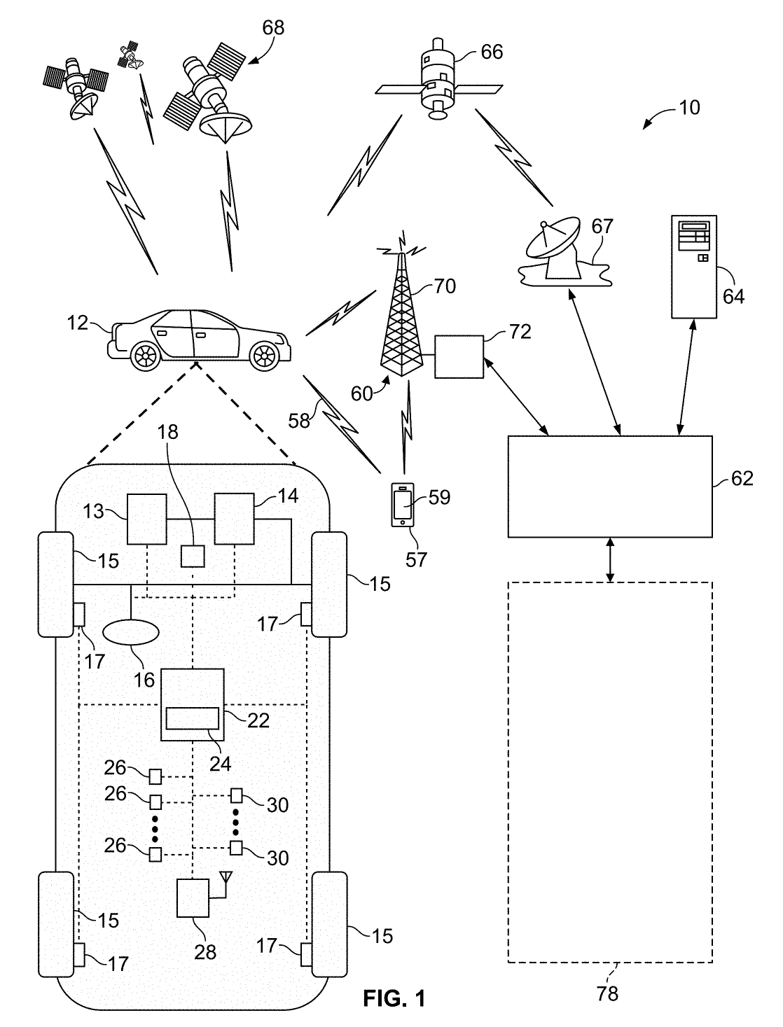

FIG. 1 schematically illustrates an operating environment that comprises a mobile vehicle communication and control system 10 for a motor vehicle 12. The communication and control system 10 for the vehicle 12 generally includes one or more wireless carrier systems 60, a land communications network 62, a computer 64, a mobile device 57 such as a smart phone, and a remote access center 78.

The vehicle 12, shown schematically in FIG. 1, is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. The vehicle 12 includes a propulsion system 13, which may in various embodiments include an internal combustion engine, an electric machine such as a traction motor, and/or a fuel cell propulsion system.

The vehicle 12 also includes a transmission 14 configured to transmit power from the propulsion system 13 to a plurality of vehicle wheels 15 according to selectable speed ratios. According to various embodiments, the transmission 14 may include a step-ratio automatic transmission, a continuously-variable transmission, or other appropriate transmission. The vehicle 12 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

The vehicle 12 additionally includes a steering system 16. While depicted as including a steering wheel for illustrative purposes, in some embodiments contemplated within the scope of the present disclosure, the steering system 16 may not include a steering wheel.

The vehicle 12 includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, wireless communications systems configured to communicate via additional or alternate wireless communications standards, such as IEEE 802.11 and cellular data communication, are also considered within the scope of the present disclosure.

The propulsion system 13, transmission 14, steering system 16, and wheel brakes 17 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 includes an automated driving system (ADS) 24 for automatically controlling various actuators in the vehicle. In an exemplary embodiment, the ADS 24 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. In an exemplary embodiment, the ADS 24 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate.

FIG. 1 illustrates several networked devices that can communicate with the wireless communication system 28 of the vehicle 12. One of the networked devices that can communicate with the vehicle 12 via the wireless communication system 28 is the mobile device 57. The mobile device 57 can include computer processing capability, a transceiver capable of communicating using a short-range wireless protocol, and a visual smart phone display 59. The computer processing capability includes a microprocessor in the form of a programmable device that includes one or more instructions stored in an internal memory structure and applied to receive binary input to create binary output. In some embodiments, the mobile device 57 includes a GPS module capable of receiving GPS satellite signals and generating GPS coordinates based on those signals. In other embodiments, the mobile device 57 includes cellular communications functionality such that the mobile device 57 carries out voice and/or data communications over the wireless carrier system 60 using one or more cellular communications protocols, as are discussed herein. The visual smart phone display 59 may also include a touch-screen graphical user interface.

The wireless carrier system 60 is preferably a cellular telephone system that includes a plurality of cell towers 70 (only one shown), one or more mobile switching centers (MSCs) 72, as well as any other networking components required to connect the wireless carrier system 60 with the land communications network 62. Each cell tower 70 includes sending and receiving antennas and a base station, with the base stations from different cell towers being connected to the MSC 72 either directly or via intermediary equipment such as a base station controller. The wireless carrier system 60 can implement any suitable communications technology, including for example, analog technologies such as AMPS, or digital technologies such as CDMA (e.g., CDMA2000) or GSM/GPRS. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from using the wireless carrier system 60, a second wireless carrier system in the form of satellite communication can be used to provide uni-directional or bi-directional communication with the vehicle 12. This can be done using one or more communication satellites 66 and an uplink transmitting station 67. Uni-directional communication can include, for example, satellite radio services, wherein programming content (news, music, etc.) is received by the transmitting station 67, packaged for upload, and then sent to the satellite 66, which broadcasts the programming to subscribers. Bi-directional communication can include, for example, satellite telephony services using the satellite 66 to relay telephone communications between the vehicle 12 and the station 67. The satellite telephony can be utilized either in addition to or in lieu of the wireless carrier system 60.

The land network 62 may be a conventional land-based telecommunications network connected to one or more landline telephones and connects the wireless carrier system 60 to the remote access center 78. For example, the land network 62 may include a public switched telephone network (PSTN) such as that used to provide hardwired telephony, packet-switched data communications, and the Internet infrastructure. One or more segments of the land network 62 could be implemented through the use of a standard wired network, a fiber or other optical network, a cable network, power lines, other wireless networks such as wireless local area networks (WLANs), or networks providing broadband wireless access (BWA), or any combination thereof. Furthermore, the remote access center 78 need not be connected via land network 62, but could include wireless telephony equipment so that it can communicate directly with a wireless network, such as the wireless carrier system 60.

While shown in FIG. 1 as a single device, the computer 64 may include a number of computers accessible via a private or public network such as the Internet. Each computer 64 can be used for one or more purposes. In an exemplary embodiment, the computer 64 may be configured as a web server accessible by the vehicle 12 via the wireless communication system 28 and the wireless carrier 60. Other computers 64 can include, for example: a service center computer where diagnostic information and other vehicle data can be uploaded from the vehicle via the wireless communication system 28 or a third party repository to or from which vehicle data or other information is provided, whether by communicating with the vehicle 12, the remote access center 78, the mobile device 57, or some combination of these. The computer 64 can maintain a searchable database and database management system that permits entry, removal, and modification of data as well as the receipt of requests to locate data within the database. The computer 64 can also be used for providing Internet connectivity such as DNS services or as a network address server that uses DHCP or other suitable protocol to assign an IP address to the vehicle 12. The computer 64 may be in communication with at least one supplemental vehicle in addition to the vehicle 12. The vehicle 12 and any supplemental vehicles may be collectively referred to as a fleet.

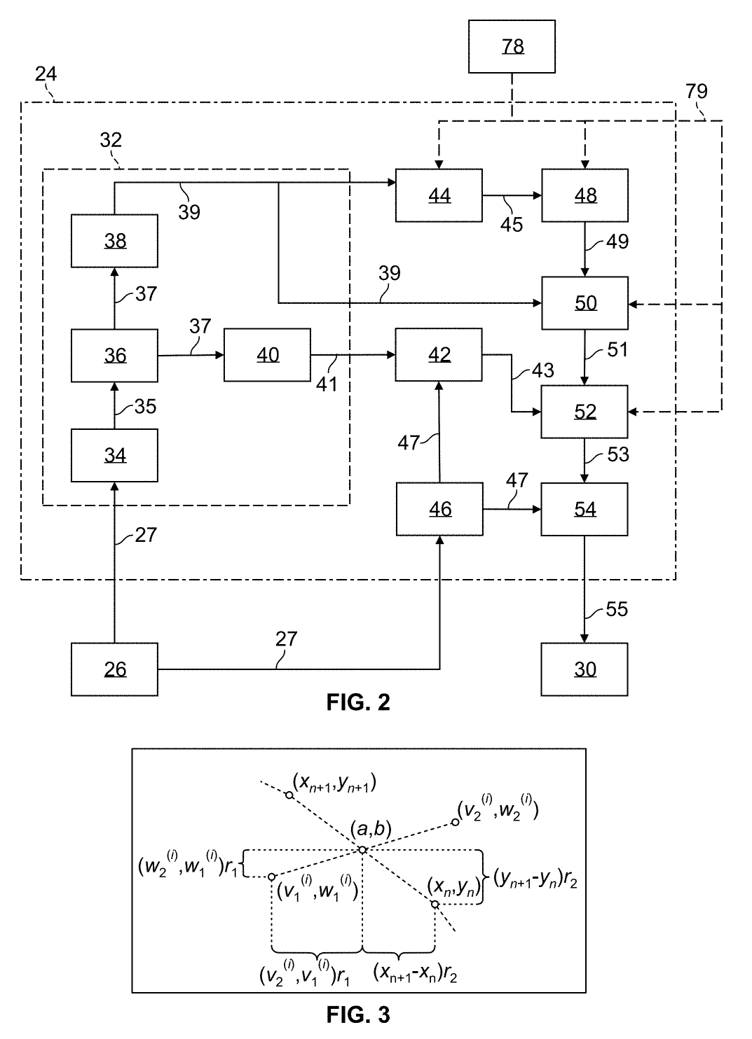

As shown in FIG. 2, the ADS 24 includes multiple distinct control systems, including at least a perception system 32 for determining the presence, location, classification, and path of detected features or objects in the vicinity of the vehicle. The perception system 32 is configured to receive inputs from a variety of sensors, such as the sensors 26 illustrated in FIG. 1, and synthesize and process the sensor inputs to generate parameters used as inputs for other control algorithms of the ADS 24.

The perception system 32 includes a sensor fusion and preprocessing module 34 that processes and synthesizes sensor data 27 from the variety of sensors 26. The sensor fusion and preprocessing module 34 performs calibration of the sensor data 27, including, but not limited to, LIDAR to LIDAR calibration, camera to LIDAR calibration, LIDAR to chassis calibration, and LIDAR beam intensity calibration. The sensor fusion and preprocessing module 34 outputs preprocessed sensor output 35.

A classification and segmentation module 36 receives the preprocessed sensor output 35 and performs object classification, image classification, traffic light classification, object segmentation, ground segmentation, and object tracking processes. Object classification includes, but is not limited to, identifying and classifying objects in the surrounding environment including identification and classification of traffic signals and signs, RADAR fusion and tracking to account for the sensor's placement and field of view (FOV), and false positive rejection via LIDAR fusion to eliminate the many false positives that exist in an urban environment, such as, for example, manhole covers, bridges, overhead trees or light poles, and other obstacles with a high RADAR cross section but which do not affect the ability of the vehicle to travel along its path. Additional object classification and tracking processes performed by the classification and segmentation model 36 include, but are not limited to, freespace detection and high level tracking that fuses data from RADAR tracks, LIDAR segmentation, LIDAR classification, image classification, object shape fit models, semantic information, motion prediction, raster maps, static obstacle maps, and other sources to produce high quality object tracks. The classification and segmentation module 36 additionally performs traffic control device classification and traffic control device fusion with lane association and traffic control device behavior models. The classification and segmentation module 36 generates an object classification and segmentation output 37 that includes object identification information.

A localization and mapping module 40 uses the object classification and segmentation output 37 to calculate parameters including, but not limited to, estimates of the position and orientation of vehicle 12 in both typical and challenging driving scenarios. These challenging driving scenarios include, but are not limited to, dynamic environments with many cars (e.g., dense traffic), environments with large scale obstructions (e.g., roadwork or construction sites), hills, multi-lane roads, single lane roads, a variety of road markings and buildings or lack thereof (e.g., residential vs. business districts), and bridges and overpasses (both above and below a current road segment of the vehicle).

The localization and mapping module 40 also incorporates new data collected as a result of expanded map areas obtained via onboard mapping functions performed by the vehicle 12 during operation and mapping data “pushed” to the vehicle 12 via the wireless communication system 28. The localization and mapping module 40 updates previous map data with the new information (e.g., new lane markings, new building structures, addition or removal of constructions zones, etc.) while leaving unaffected map regions unmodified. Examples of map data that may be generated or updated include, but are not limited to, yield line categorization, lane boundary generation, lane connection, classification of minor and major roads, classification of left and right turns, and intersection lane creation. The localization and mapping module 40 generates a localization and mapping output 41 that includes the position and orientation of the vehicle 12 with respect to detected obstacles and road features.

A vehicle odometry module 46 receives data 27 from the vehicle sensors 26 and generates a vehicle odometry output 47 which includes, for example, vehicle heading and velocity information. An absolute positioning module 42 receives the localization and mapping output 41 and the vehicle odometry information 47 and generates a vehicle location output 43 that is used in separate calculations as discussed below.

An object prediction module 38 uses the object classification and segmentation output 37 to generate parameters including, but not limited to, a location of a detected obstacle relative to the vehicle, a predicted path of the detected obstacle relative to the vehicle, and a location and orientation of traffic lanes relative to the vehicle. Data on the predicted path of objects (including pedestrians, surrounding vehicles, and other moving objects) is output as an object prediction output 39 and is used in separate calculations as discussed below.

The ADS 24 also includes an observation module 44 and an interpretation module 48. The observation module 44 generates an observation output 45 received by the interpretation module 48. The observation module 44 and the interpretation module 48 allow access by the remote access center 78. The interpretation module 48 generates an interpreted output 49 that includes additional input provided by the remote access center 78, if any.

A path planning module 50 processes and synthesizes the object prediction output 39, the interpreted output 49, and additional routing information 79 received from an online database or the remote access center 78 to determine a vehicle path to be followed to maintain the vehicle on the desired route while obeying traffic laws and avoiding any detected obstacles. The path planning module 50 employs algorithms configured to avoid any detected obstacles in the vicinity of the vehicle, maintain the vehicle in a current traffic lane, and maintain the vehicle on the desired route. The path planning module 50 outputs the vehicle path information as path planning output 51. The path planning output 51 includes a commanded vehicle path based on the vehicle route, vehicle location relative to the route, location and orientation of traffic lanes, and the presence and path of any detected obstacles.

A first control module 52 processes and synthesizes the path planning output 51 and the vehicle location output 43 to generate a first control output 53. The first control module 52 also incorporates the routing information 79 provided by the remote access center 78 in the case of a remote take-over mode of operation of the vehicle.

A vehicle control module 54 receives the first control output 53 as well as velocity and heading information 47 received from vehicle odometry 46 and generates vehicle control output 55. The vehicle control output 55 includes a set of actuator commands to achieve the commanded path from the vehicle control module 54, including, but not limited to, a steering command, a shift command, a throttle command, and a brake command.

The vehicle control output 55 is communicated to actuators 30. In an exemplary embodiment, the actuators 30 include a steering control, a shifter control, a throttle control, and a brake control. The steering control may, for example, control a steering system 16 as illustrated in FIG. 1. The shifter control may, for example, control a transmission 14 as illustrated in FIG. 1. The throttle control may, for example, control a propulsion system 13 as illustrated in FIG. 1. The brake control may, for example, control wheel brakes 17 as illustrated in FIG. 1.

Known algorithms which may be used in the object prediction module 38 rely on deterministic calculations, e.g. calculating a future position of a detected object relative to the host vehicle based on the current position, velocity, and acceleration of the detected object relative to the host vehicle. However, such algorithms may be computationally-intensive, as they involve performing a distinct computation for each detected object at each time interval of interest.

The present disclosure relates to a system and method for generating and utilizing a spatial probabilistic representation of the future states of detected objects. In an exemplary embodiment, the spatial representation is encoded as a top-down view heatmap which may be used by a host vehicle, e.g. the vehicle 12. In such embodiments, the heatmap provides the probability of other vehicle locations at times corresponding to when the other vehicles could contact the host vehicle based on a planned trajectory for the host vehicle. Advantageously, rather of producing and processing multiple heatmaps at distinct and successive time instances in the future, only one heatmap is produced that encodes all of the relevant temporal information.

The following describes an exemplary method for to generating probabilistic heatmaps given a planned trajectory for a host vehicle that is parameterized in time as well as the positions, headings, and velocities of other nearby vehicles. However, the scope of the present disclosure is not strictly limited to the specific method discussed below, as one of ordinary skill in the art will appreciate that variations on the below method are possible.

A planned trajectory P of the host vehicle may be defined as a discrete set of points that exists in a two-dimensional Cartesian space that represents the top-down view of a traffic scenario. P is time-parameterized in discrete time, denoted by the set t={t_{M}, t_{M+1}, . . . , t_{N-1}, t_{N}}, where time t_{M} corresponds to the initial point (x_{M}, y_{M}) of P, and time t_{N} corresponds to the final point (x_{N}, y_{N}). Any given point (xₙ, yₙ) of P corresponds to a time tₙ that indicates the time necessary for the host vehicle to reach the point (xₙ, yₙ). The point on P corresponding to the host vehicle's current position (x₀, y₀) is parameterized with the time to =0. Similarly, all points on P that the host vehicle has already traveled, denoted as (x⁻, y⁻), where x⁻={x_{M}, x_{M+1}, . . . , x₋₂, x₋₁} and y⁻={y_{M}, y_{M+1}, . . . , y₋₂, y₋₁}, are parameterized with the times that are identically zero: t⁻={t_{M}=0, t_{M+1}=0, . . . , t₋₂=0, t₋₁=0}. The times where the host vehicle will be in the future may be defined as t⁺={t₁, t₂, . . . , t_{N-1}, t_{N}}, the set of time parameters can then be represented as t={t⁻, t₀, t⁺}. This provides the interpretation of P as a set of points indicating where the host vehicle has traveled, where it is currently, and where it will be in the future.

To find where other detected objects, e.g. vehicles, will intersect with the curve formed by the points in P, line segments may be constructed for each object in the sense that represents the direction of its heading. The i^{th} vehicle's current location may be represented as T₁⁽ⁱ⁾=(v₁⁽ⁱ⁾, w₁⁽ⁱ⁾) and its heading as φ⁽ⁱ⁾, and then a line segment may be created in the direction of the heading by defining the i^{th} vehicle's arbitrary future location

T₂⁽ⁱ⁾=(R cos φ⁽ⁱ⁾+v₁⁽ⁱ⁾,R sin φ⁽ⁱ⁾+w₁⁽ⁱ⁾)=(v₂⁽ⁱ⁾,w₂⁽ⁱ⁾)

where R is some arbitrary range to create a line segment long enough to intersect with the curve formed by the points in P.

The approach to finding the intersections is to check whether the line segment T̅₁̅^̅{̅(̅l̅)̅}̅T̅₂̅^̅{̅(̅l̅)̅}̅ intersects with each line segment Lₙ formed by pairs of consecutive points (xₙ, yₙ) and (xₙ₊₁, yₙ₊₁) in P. This may be performed by solving the following four equations:

(v₂⁽ⁱ⁾−v₁⁽ⁱ⁾)=r₁=a−v₁⁽ⁱ⁾

(xₙ₊₁−xₙ)r₂=a−xₙ

(w₂⁽ⁱ⁾−w₁⁽ⁱ⁾)r₁=b−w₁⁽ⁱ⁾

(yₙ₊₁−yₙ)r₂=b−yₙ

The point (a, b) is where the two line segments intersect, r₁ is the distance from T₁⁽ⁱ⁾ to (a, b), and r₂ is the distance from the first point of Lₙ to (a, b). This approach is illustrated in FIG. 3. The four equations may be rewritten in matrix form in order to solve for the four unknowns:

$$[ \begin{matrix}{v}_{2}^{( i )} - {v}_{1}^{( i )} & 0 & - 1 & 0 \\ 0 & {x}_{n + 1} - {x}_{n} & - 1 & 0 \\ {w}_{2}^{( i )} - {w}_{1}^{( i )} & 0 & 0 & - 1 \\ 0 & {y}_{n + 1} - {y}_{n} & 0 & - 1\end{matrix} ] [ \begin{matrix}{r}_{1} \\ {r}_{2} \\ a \\ b\end{matrix} ] = [ \begin{matrix}- {v}_{1}^{( i )} \\ - {x}_{n} \\ - {w}_{1}^{( i )} \\ - {y}_{n}\end{matrix} ]$$

After finding the intersection point (a, b), the line segment Lₙ of P that contains the intersection with T̅₁̅^̅{̅(̅l̅)̅}̅T̅₂̅^̅{̅(̅l̅)̅}̅ may be identified. Therefore, the intersection time tᵢ⁽ⁱ⁾ corresponding to the point (a, b) can be found by a linear interpolation by knowing the distance r₂ and the time parameters tₙ and tₙ₊₁ that correspond to the pair of points in Lₙ. The intersection time tᵢ⁽ⁱ⁾ represents the time when the host vehicle will reach a point in P that is intersected by T̅₁̅^̅{̅(̅l̅)̅}̅T̅₂̅^̅{̅(̅l̅)̅}̅. Therefore, tᵢ⁽ⁱ⁾ indicates the time when there is potential contact between the host vehicle and the i^{th} vehicle. The set of all intersection times tᵢ, which contains the intersection times for all of the other vehicles in the traffic scenario, therefore contains all of the relevant temporal information necessary for collision avoidance. If T̅₁̅^̅{̅(̅l̅)̅}̅T̅₂̅^̅{̅(̅l̅)̅}̅ does not intersect with any Lₙ, then there will not be a solution, and thus the corresponding other vehicle will not have an intersection time. In such cases, the intersection time may be set to zero: tᵢ⁽ⁱ⁾=0.

To know whether contact will occur, the locations of all the other vehicles at their respective times in tᵢ may be used. This uses the current, or instantaneous, velocity u of each other vehicle. Assuming that all of the other vehicles will maintain their heading, the expected position of the i^{th} vehicle is given by:

Tₑ⁽ⁱ⁾=(u⁽ⁱ⁾tᵢ⁽ⁱ⁾cos φ⁽ⁱ⁾+v₁⁽ⁱ⁾,u⁽ⁱ⁾tᵢ⁽ⁱ⁾sin φ⁽ⁱ⁾+w₁⁽ⁱ⁾)=(vₑ⁽ⁱ⁾,wₑ⁽ⁱ⁾)

If the intersection time tᵢ⁽ⁱ⁾=0, it belongs to the set {t⁻, t₀}. This means that the other vehicle's heading intersects at a point where the host vehicle has already traveled or where the host vehicle is currently positioned. It may also mean that there was no solution to the system of linear equations. Therefore, the other vehicle will not be on a path to contact the host vehicle, and in this case, the definition of the time parameterization is such that the other vehicle's expected position becomes its current position: Tₑ⁽ⁱ⁾=(v₁⁽ⁱ⁾,w₁⁽ⁱ⁾)=T₁⁽ⁱ⁾.

These expected positions Tₑ⁽ⁱ⁾ also correspond to the means μ⁽ⁱ⁾ of the Gaussian distribution that can be used to represent the probability of Tₑ⁽ⁱ⁾ on the heatmap. The covariance matrix of the Gaussian distribution may encode the other vehicle's heading and velocity. This can be done by an eigendecomposition of the covariance matrix, where the eigenvectors are aligned with the heading and the eigenvalues are some function of the velocity. For vehicles whose T̅₁̅^̅{̅(̅l̅)̅}̅T̅₂̅^̅{̅(̅l̅)̅}̅ does not intersect with any Lₙ, a decision may be made as to whether or not they should have any heat representation in the heatmap. If T̅₁̅^̅{̅(̅l̅)̅}̅T̅₂̅^̅{̅(̅l̅)̅}̅ does not intersect with any Lₙ, then the corresponding vehicle is not in any position to potentially contact the host vehicle, so computation can be saved by ignoring such vehicles.

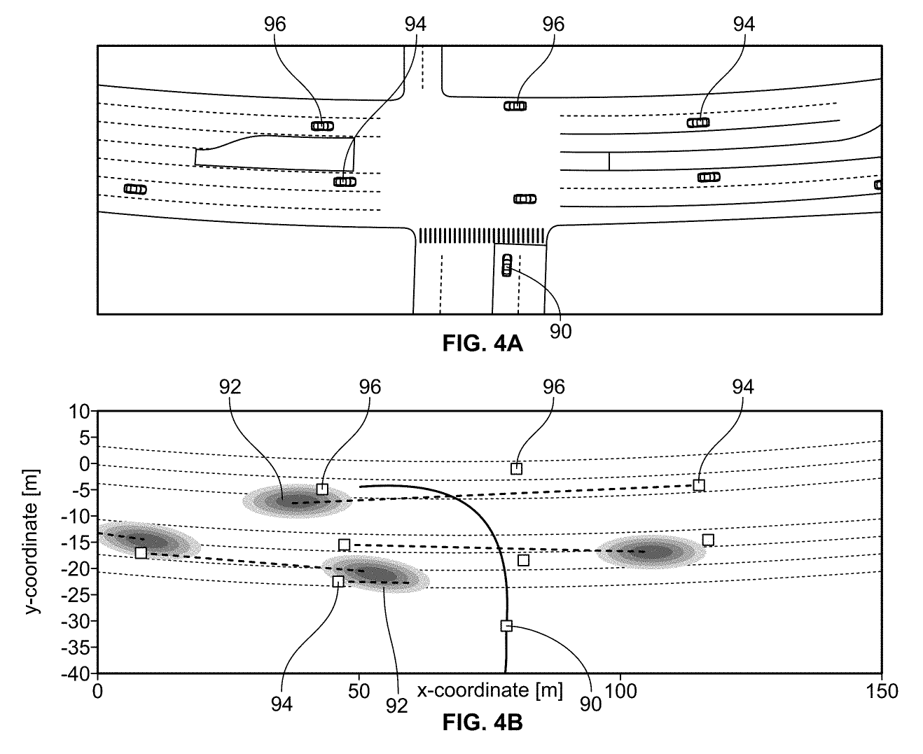

Referring now to FIGS. 4A and 4B, an illustrative traffic scenario is shown in 4A and the corresponding heatmap is shown in 4B. A host vehicle 90, which may be configured as the vehicle 12 as discussed above, approaches an intersection. Gaussian distributions 92 are calculated for detected objects, e.g. vehicles 94, generally as discussed above. In the illustrated embodiment, Gaussian distributions are not provided for vehicles 96 because their headings do not intersect with P.

Once generated, the heat map may be included in the object prediction output 39 for use by the path planning module 50, as will be discussed below.

At time tᵢ, a set of k heat maps, ϕₜ_{ᵢ}, . . . , ϕₜ_{_{k+i−1}}, forecasting from the current time, tᵢ, to future time, tₖ₊ᵢ₋₁, are input to the system. These maps are specified over a two-dimensional spatial grid (e.g., x, y, coordinates) defining a region of the road that is to be navigated, e.g. generally as discussed above. Seen as scalar functions, ϕ(x, y), of the grid points, the values of the heat maps at the grid points reflect the relative probability that an obstacle will be present at that grid cell.

Each heat map can be interpreted as an artificial potential field at an instant in time. The gradient of this potential field, ϕ, is denoted ∇ϕ. The gradient field provides repulsive forces to the vehicle. The vehicle dynamics may be modeled as point mass in a gradient field with a dissipative term and a proportional control law to track the trajectory, x_{d}. The dynamical system is then M\ddot{x}=−∇ϕ−B\dot{x}+K(x_{d}−x), where M is the mass, B, is the damping coefficient, Kis the proportional gain, and x is the 2-dimensional position vector of the point mass. Numerically integrating the dynamical system from tᵢ→tₖ₊₁ yields the trajectory Pₜ_{ᵢ}_{→t}_{ₖ₊ᵢ}. When integrating the dynamical system, ∇ϕ=∇ϕₜ_{ᵣ} over the interval from tᵣ→tᵣ₊₁. The generated trajectory may then be tested for feasibility based on a criterion (e.g., variation from nominal trajectory). If feasible it may be executed by the controller. Updated trajectories are generated over a receding time horizon until completion.

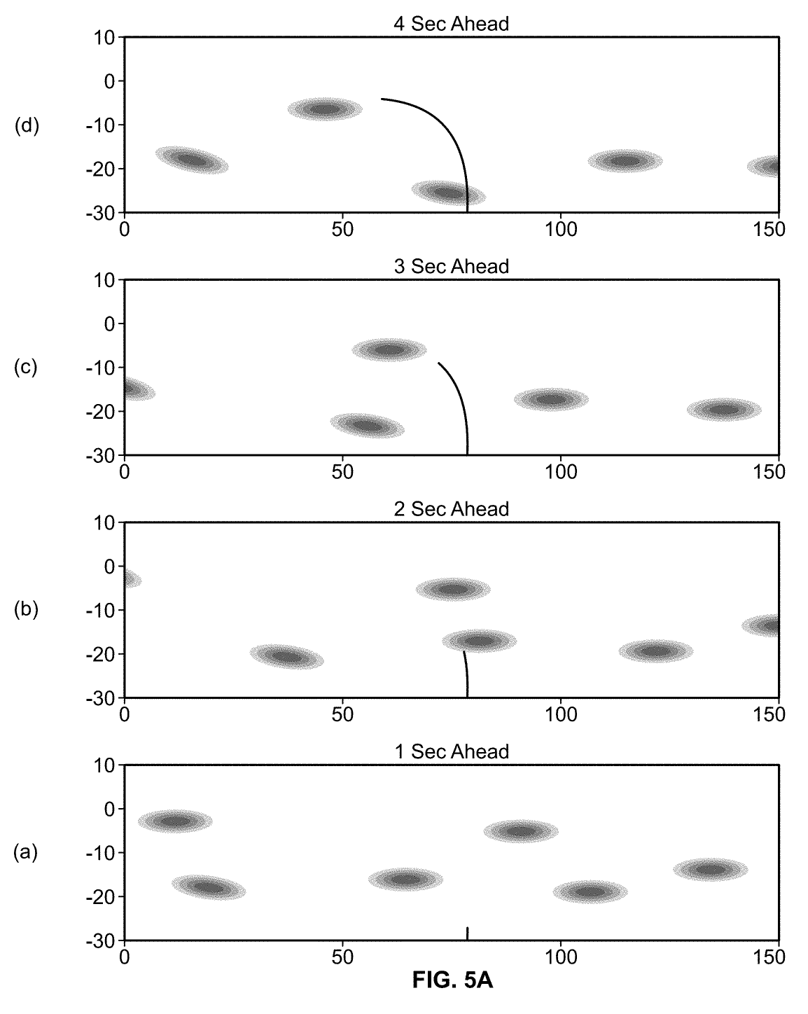

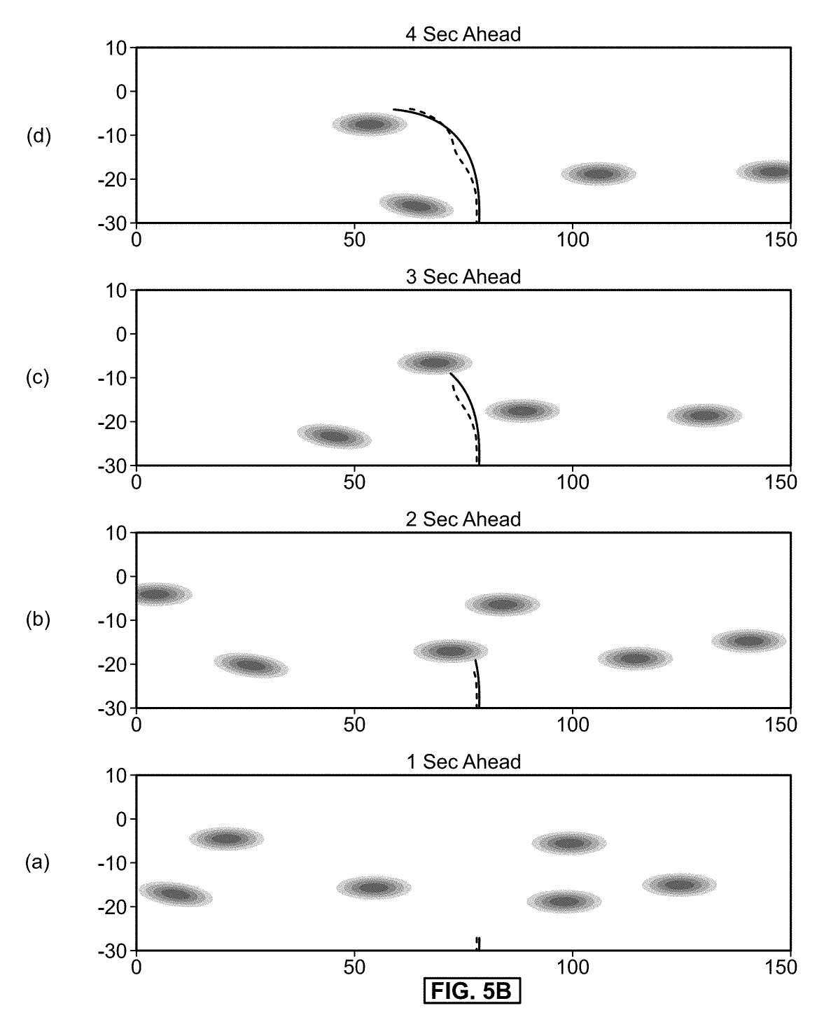

FIG. 5 depicts simulation results associated with a point mass following a nominal trajectory in an evolving potential field associated with a sequence of k=4 predictive heat maps. At time tᵢ heat maps, ϕₜ_{ᵢ}, ϕₜ_{ᵢ₊₁}, ϕₜ_{ᵢ₊₂}, ϕₜ_{ᵢ₊₃}, are presented. The point mass tracks the nominal trajectory with a simple proportional control law while the gradient field, ∇ϕₜ_{ᵢ}, is in effect over the interval tᵢ→tᵢ₊₁ (a), followed by ∇ϕₜ_{₊₁} in effect over the interval tᵢ₊₁→tᵢ₊₂ (b), followed by ∇ϕₜ_{ᵢ₊₂} in effect over the interval tᵢ₊₂→tᵢ₊₃ (c), and finally ∇ϕₜ_{ᵢ₊₃} in effect over the interval tᵢ₊₃→tᵢ₊₄ (d). The associated trajectory of the point mass, Pₜ_{ᵢ}_{→t}_{ᵢ₊₄}, is tested for feasibility. In the embodiment illustrated in FIG. 5A the system uses a conservative criterion for feasibility, waiting until a sequence of heat maps occurs where little or no deviation from the nominal trajectory is required. In the embodiment illustrated in FIG. 5B the system uses a more aggressive criterion for feasibility, waiting until a sequence of heat maps occurs where a larger deviation from the nominal trajectory is allowed.

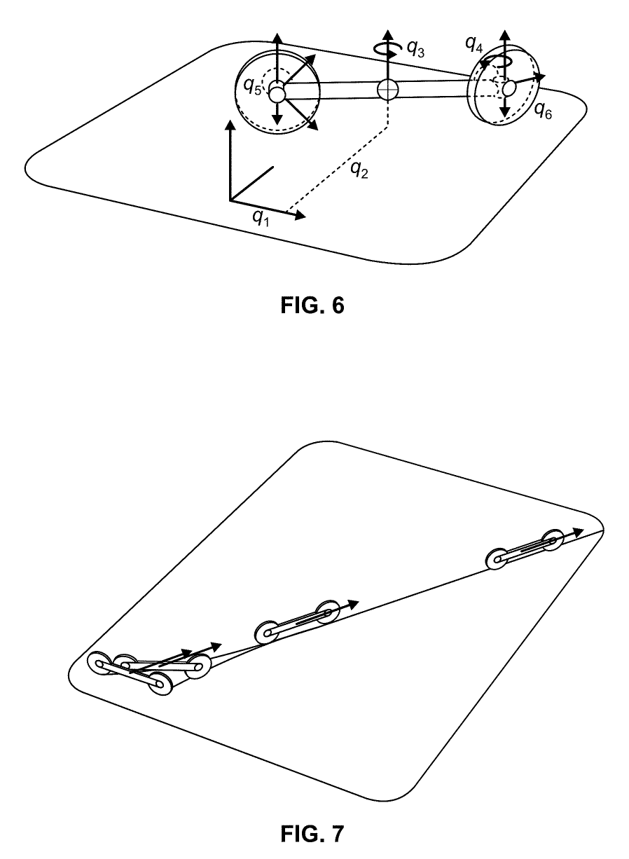

In an alternative embodiment, an arbitrary multibody model may be used rather than a simple point mass as the vehicle model. For an automobile so-called nonholonomic constraints can be imposed that restrict the motion consistent with vehicle capabilities. FIG. 6 depicts a simplified automobile model called a bicycle model. Generalized coordinates q₁ and q₂ locate the center of mass of the chassis, while q₃ is the yaw angle of the chassis. The steering angle is defined by q₄, and the rear and front tire rotation angles are q₅ and q₆, respectively. Nonholonomic constraints (no-slip conditions) require the relative motion between the contact points of the tires with the ground to be zero.

The unconstrained equations of motion of this system can be represented in standard form as τ=M(q)\ddot{q}+b(q, \dot{q})+g(q), where q is the vector of generalized coordinates, τ is the vector of generalized forces, M (q) is the system mass matrix, b(q, \dot{q}) is the centrifugal and Coriolis force vector, and g(q) is the gravity force vector. The nonholonomic constraints can be represented in the form, C (q)\dot{q}=0. This system can be represented in the form W^{T}τ=\tilde{M}(q)\dot{s}+(q, s)+\tilde{g}(q), where im(W)=ker(C) and

$$\tilde{M} ( q ) = {W}^{T} MW$$

$$\tilde{b} ( q , s ) = {W}^{T} b + {W}^{T} M \dot{W} s$$

$$\tilde{g} ( q ) = {W}^{T} g$$

$$s = ( \begin{matrix}{s}_{1} \\ {s}_{2}\end{matrix} ) = ( \begin{matrix}\dot{{q}_{4}} \\ \dot{{q}_{6}}\end{matrix} )$$

These dynamics may be incorporated directly in the potential field dynamical system,

$$\tilde{M} ( q ) \dot{s} + \tilde{b} ( q , s ) + \tilde{g} ( q ) = {W}^{T} ( \begin{matrix}{f}_{x} \\ {f}_{y} \\ 0\end{matrix} ) = {W}^{T} ( \begin{matrix}- ∇ φ - {Bx}^{\cdot } + k ( {x}_{d} - x ) \\ 0\end{matrix} ) .$$

The gradient of the potential field, −∇ϕ, and the proportional tracking controller, K(x_{d}−x), are forces that act directly on the center of mass of the chassis, with x being the 2-dimensional position vector of the center of mass. FIG. 7 depicts a simulation of the nonholonomic vehicle dynamics responding to a force acting on the chassis. This demonstrates how complex vehicle dynamic models can easily be incorporated into the system.

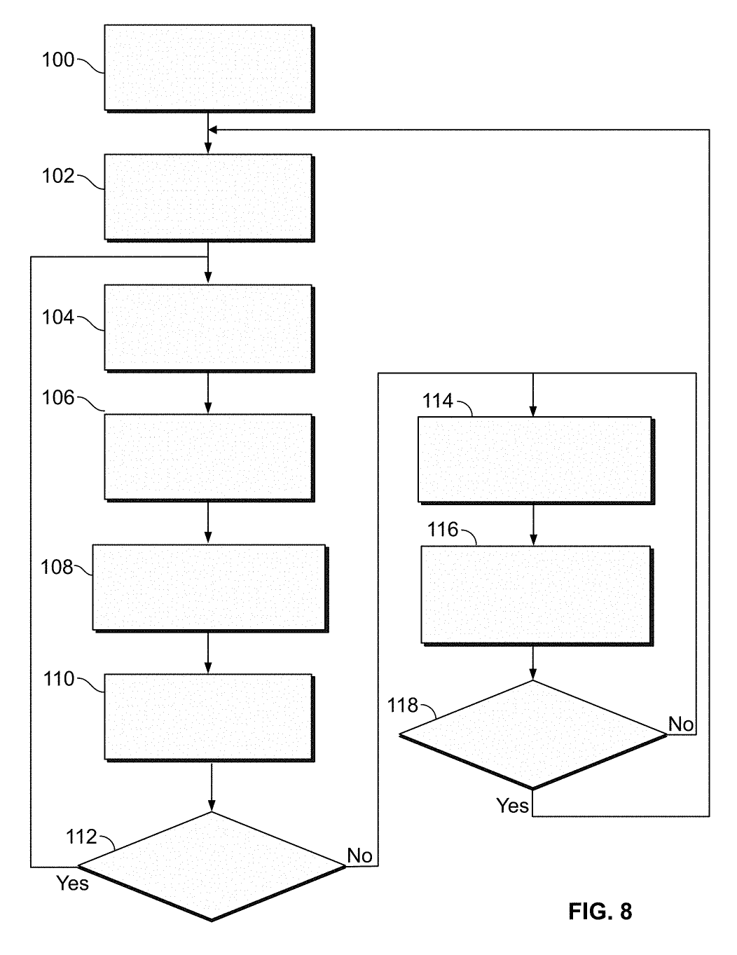

Referring now to FIG. 8, a method of controlling a vehicle according to the present disclosure is illustrated in flowchart form. The method begins with the host vehicle under the control of an automated driving system, as illustrated at block 100. In an exemplary embodiment, the host vehicle is configured generally similar to the vehicle 12 discussed above.

A nominal vehicle path is calculated, as illustrated at block 102. The nominal vehicle path refers to a vehicle path to be followed in the absence of any moving objects, such as vehicles, in the vicinity of the host vehicle. The path may be calculated, e.g., by the controller 22

At least one object is detected proximate the host vehicle, as illustrated at block 104. The object may refer to another vehicle, pedestrian, or any other moving object as applicable. In an exemplary embodiment, the detection is performed by one or more sensors 26, e.g. LiDAR.

A relative position, velocity, and acceleration of the detected object is determined, as illustrated at block 106.

A probabilistic forecast of the future location of the detected object is calculated, as illustrated at block 108. In an exemplary embodiment, the probabilistic forecast comprises a heatmap as discussed above.

A vehicle trajectory is calculated based on the probabilistic forecast, as illustrated at block 110. In an exemplary embodiment, this is performed as discussed above with respect to FIG. 5.

A determination is made of whether the trajectory satisfies at least one variance criterion, e.g. whether the trajectory deviates from the nominal path by less than a threshold deviation, as illustrated at operation 112.

If the variance criterion is not satisfied, i.e. the trajectory deviates from the nominal path by more than the threshold deviation, then control returns to block 104. The algorithm therefore waits until the criterion is satisfied before proceeding.

If the variance criterion is satisfied, then the trajectory is executed, as illustrated at block 114. In an exemplary embodiment, this includes controlling one or more actuators 30, such as steering and acceleration actuators, to drive the vehicle along the trajectory.

The probabilistic forecast is recalculated and the trajectory is updated based on the recalculated forecast, as illustrated at block 116. The algorithm may thereby accommodate any changes to the probabilistic forecast which arise due to changes in behavior of detected objects in the vicinity of the host vehicle.

A determination is made of whether the maneuver is complete, as illustrated at operation 118. If the determination is negative, i.e. the maneuver has not been completed, then control returns to block 114 to continue executing the trajectory. If the determination is positive, i.e. the maneuver is complete, then control returns to block 102 to prepare for any subsequent maneuver.

As may be seen the present disclosure provides a system and method for controlling an autonomous vehicle to avoid contacting other objects or vehicles, and moreover does so in a computationally-efficient manner. This may increase vehicle responsiveness and, in turn, customer satisfaction.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
an actuator configured to control vehicle acceleration, steering, or braking;
at least one sensor configured to detect an object in the vicinity of the vehicle; and
at least one controller configured to automatically control the actuator according to an automated driving system algorithm, the at least one controller being configured to define a first vehicle route, detect at least one object in the vicinity of the vehicle; calculate a probabilistic forecast of a future location of the at least one detected object, define a second vehicle route in response to the probabilistic forecast indicating proximity of the at least one detected object to the first route, and to control the actuator to execute the second vehicle route.

2. The automotive vehicle of claim 1, wherein the probabilistic forecast comprises a two-dimensional heatmap of a vicinity of the vehicle.

3. The automotive vehicle of claim 2, wherein the at least one detected object comprises a first object and a second object, a relative path of the first object intersecting the first vehicle route, a relative path of the second object not intersecting the vehicle route, and wherein the heatmap includes a gaussian distribution associated with the first object and no gaussian distribution associated with the second object.

4. A method of controlling an automotive vehicle, comprising:
providing a vehicle with an actuator configured to control vehicle acceleration,
steering, or braking, at least one sensor configured to detect an object in the vicinity of the vehicle, and at least one controller configured to automatically control the actuator according to an automated driving system algorithm;
detecting, via the at least one sensor, at least one object in the vicinity of the vehicle;
calculating, via the controller, a probabilistic forecast of a future location of the at least one detected object;
defining a vehicle path from a current vehicle location to a desired future vehicle location, the vehicle path being based on the probabilistic forecast; and
automatically controlling the actuator, via the controller, to execute the vehicle path.

5. The method of claim 4, wherein defining a vehicle path comprises defining a time-parametrized path having a first set of time parameters, and wherein the probabilistic forecast comprises a second set of time parameters corresponding to the first set of time parameters.

6. The method of claim 5, further comprising, in response to the probabilistic forecast indicating proximity of the at least one detected object to the time parametrized path, defining a second vehicle path from the current vehicle location to the desired future location, the second vehicle path not being proximate the at least one detected object.

7. The method of claim 6, further comprising, in response to the second vehicle path being within a predefined range of the vehicle path, automatically controlling the actuator, via the controller, to execute the second vehicle path.

8. The method of claim 4, wherein the probabilistic forecast comprises a two-dimensional heatmap of a vicinity of the vehicle.

9. The method of claim 8, wherein the at least one detected object comprises a first object and a second object, a relative path of the first object intersecting the vehicle route, a relative path of the second object not intersecting the vehicle route, and wherein the heatmap includes a gaussian distribution associated with the first object and no gaussian distribution associated with the second object.
